(19) United States
(12) Patent Application Publication
(10) Pub. No.: US 2020/0065274 A1
(43) Pub. Date: Feb. 27, 2020

(54) ALWAYS-ON IBI HANDLING

(71) Applicant: QUALCOMM Incorporated, San Diego, CA (US)

(72) Inventors: Sharon Graif, Zichron Yakov (IL); David Teb, Haifa (IL); Oren Nishry, Haifa (IL)

(21) Appl. No.: 16/110,129

(22) Filed: Aug. 23, 2018

(51) Int. Cl. G06F 13/24; G06F 13/42

(52) U.S. Cl. CPC G06F 13/24; G06F 1/3287; G06F 13/4282

(57) ABSTRACT

Methods and apparatuses for IBI handling are provided. The apparatus includes at least one processing unit, a host controller configured to communicate with at least one slave via an I3C link and configured to enter into a low-power mode. The I3C link includes a serial clock (SCL) line and a serial data (SDA) line. The apparatus further includes an IBI detection module configured to detect while the host controller is in the low-power mode, on the SDA line, an in-band interrupt (IBI) request from the at least one slave and a processing unit interrupt control module configured to signal a processing unit interrupt to the at least one processing unit based on information of the IBI request, in the case the host controller is in the low-power mode, in response to the IBI detection module detecting the IBI request.

### BACKGROUND

### Field

The present disclosure relates generally to an interface between processors and peripheral devices and, more particularly, enhancing capabilities for in-band interrupts.

### Background

A computing device (e.g., a laptop, a mobile phone, etc.) may perform various functions, such as telephony, wireless data access, and camera/video function, etc. Such computing device may include a variety of components including circuit boards, integrated circuit (IC) devices and/or System-on-Chip (SoC) devices. The components may include processing circuits, user interface components, storage and other peripheral components that communicate through a serial bus. In one example, the serial bus may be operated in accordance with Inter-Integrated Circuit protocols, which may also be referred to as I2C protocols or I²C protocols. The I2C protocols are operable on a serial, single-ended bus used for connecting low-speed peripherals to a processor. In some examples, a serial bus may employ a multi-master protocol in which one or more devices can serve as a master and a slave for different messages transmitted on the serial bus. Data may be serialized and transmitted in a data signal carried on a Serial Data (SDA) line (SDA), in accordance with timing provided in a clock signal carried on a Serial Clock (SCL) Line.

In some examples, the serial bus may be operated in accordance with I3C protocols defined by the Mobile Industry Processor Interface (MIPI) Alliance. The I3C protocol can increase available bandwidth on the serial bus through higher transmitter clock rates, by encoding data in symbols defining signaling state of two or more wires, and/or through other encoding techniques including double data rate transmissions (where data is clocked using rising and falling edges of a transmitted clock signal). Certain aspects of the I3C protocol are derived from corresponding aspects of the I2C protocol, and the I2C and I3C protocols can coexist on the same serial bus (e.g., on the SDA line and the SCL line).

In a system implementing an I3C bus, a slave device may signal an in-band interrupt (IBI) request to a master device (also referred to as an I3C host). If a central processing unit (CPU or multiple CPUs in some scenarios) of the master device is operating in a low-power mode (e.g., a sleep mode), the master device will need to read the IBI data and wake up the CPU to read any subsequent data from the slave device. For example, when the master device incorporates multiple CPUs, handling of an IBI request from a slave device would require the master device to first to wake up a manager CPU of the master device and then wake up the relevant CPU to which the IBI is directed. Each waking up of a CPU at the master device consumes power and time, to the detriment of system performance.

As the computing device grows in functions and shrinks in physical dimension, improving performance and reducing power consumption become increasingly challenging. A more efficient scheme to handle an IBI request is needed.

### SUMMARY

This summary identifies features of some example aspects and is not an exclusive or exhaustive description of the disclosed subject matter. Additional features and aspects are described and will become apparent to persons skilled in the art upon reading the following detailed description and viewing the drawings that form a part thereof.

An apparatus in accordance with at least one embodiment includes at least one processing unit, a host controller configured to communicate with at least one slave via an I3C link and configured to enter into a low-power mode. The I3C link includes a serial clock (SCL) line and a serial data (SDA) line. The apparatus further includes an IBI detection module configured to detect while the host controller is in the low-power mode, on the SDA line, an in-band interrupt (IBI) request from the at least one slave; and a processing unit interrupt control module configured to signal a processing unit interrupt to the at least one processing unit based on information of the IBI request, in the case the host controller is in the low-power mode, in response to the IBI detection module detecting the IBI request.

Another apparatus in accordance with at least one embodiment includes at least one processing unit and a host controller configured to communicate with at least one slave via an I3C link. The I3C link includes a serial clock (SCL) line and a serial data (SDA line). The apparatus further includes an IBI detection module configured to detect, on the SDA line, a plurality of IBI requests from at least one slave; and a processing unit interrupt control module configured to signal an initial processing unit interrupt to the at least on processing unit, in response to the IBI detection module detecting one of the plurality of IBI requests, after the IBI detection module detects the plurality of IBI requests.

A method for in-band interrupt (IBI) handling in a low-power mode, in accordance with at least one embodiment, includes communicating between a host controller and at least one slave via an I3C link. The I3C link includes a serial clock (SCL) line and a serial data (SDA) line. The method further includes entering into the low-power mode by the host controller; detecting, by an IBI detection module, an IBI request on the SDA line from the at least one slave, while the host controller is in the low-power mode; and signaling, by a processing unit interrupt control module, a processing unit interrupt to at least one processing unit based on information of the IBI request, in response to the IBI detection module detecting the IBI request, while the host controller is in the low-power mode.

Another method for in-band interrupt (IBI) handling, in accordance with at least one embodiment, includes communicating between a host controller and at least one slave via an I3C link. The I3C link includes a serial clock (SCL) line and a serial data (SDA) line. The method further includes detecting, by an IBI detection module, an IBI request on the SDA line from the at least one slave; and signaling, by a processing unit interrupt control module, an initial processing unit interrupt to the at least on processing unit, in response to the IBI detection module detecting one of the plurality of IBI requests, after the IBI detection module detects the plurality of IBI requests.

### BRIEF DESCRIPTION OF THE DRAWINGS

Various aspects of apparatus and methods will now be presented in the detailed description by way of example, and not by way of limitation, with reference to the accompanying drawings, wherein:

FIG. 1 illustrates components of an apparatus having an I3C link.

FIG. 2 illustrates an apparatus having an I3C link, in accordance with certain aspects of the disclosure.

FIG. 3 illustrates an IBI handling module of FIG. 2.

FIG. 4 illustrates a waveform diagram of an IBI request and response.

FIG. 5 illustrates out of order signaling of processing unit interrupts.

FIG. 6 illustrates a first portion of a method for IBI handling in a low-power mode.

FIG. 7 illustrates a second portion of the method for IBI handling in a low-power mode of FIG. 6.

FIG. 8 illustrates a first portion of a method for IBI handling.

FIG. 9 illustrates a second portion of the method for IBI handling of FIG. 8.

### DETAILED DESCRIPTION

The detailed description set forth below in connection with the appended drawings is intended as a description of various configurations and is not intended to represent the only configurations in which the concepts described herein may be practiced. The detailed description includes specific details for providing a thorough understanding of various concepts. However, it will be apparent to those skilled in the art that these concepts may be practiced without these specific details. In some instances, well known structures and components are shown in block diagram form to avoid obscuring such concepts.

As used herein, the term “coupled to” in the various tenses of the verb “couple” may mean that element A is directly connected to element B or that other elements may be connected between elements A and B (i.e., that element A is indirectly connected with element B). In the case of electrical components, the term “coupled to” may also be used herein to mean that a wire, trace, or other electrically conductive material is used to electrically connect elements A and B (and any components electrically connected therebetween). In some examples, the term “coupled to” indicate having an electric current flowing between the elements A and B. In some examples, the term “electrically connected” may indicate having an electric current flowing between the elements A and B.

The terms “first,” “second,” “third,” etc. are employed for ease of reference and may not carry substantive meanings. Likewise, names for components/modules may be adopted for ease of reference and might not limit the components/modules. For example, such non-limiting names may include “IBI handling” module, “IBI detection” module, “processing unit interrupt control” module, and/or “IBI response” module. Modules and components presented in the disclosure may be implemented in hardware, software, or a combination of hardware and software.

The term “bus system” may provide that elements coupled to the “bus system” may exchange information therebetween, directly or indirectly. In such fashion, the “bus system” may encompass multiple physical connections as well as intervening stages such as buffers, latches, registers, etc.

In the disclosure, the term “I3C link” may refer to a bus operating under a MIPI Alliance I3C specification (e.g., the host controller being configured to operate the I3C link meeting all requirements of the MIPI I3C specification). The term “I3C link” may refer to a bus having an SCL line and an SDA line and/or operating under some or all of the I3C specification, from any standard setting bodies. For example, an I3C link may be a bus operating under some or all of Common Command Codes provided by the MIPI Alliance I3C specification.

Methods and apparatuses for efficient (e.g. always-on) IBI handling are presented. A master (e.g., a master device) may include a host controller to communicate with one or more slaves (e.g., slave devices) via an I3C link. For example, the host controller may be configured to comply with requirements of an MIPI Alliance specification to communicate via the I3C link. The host controller or parts of the host controller may, at times, enter into a low-power mode (e.g., a sleep mode; a power-down mode). The in-band interrupt (IBI) handling module may be configured to detect IBI interrupts on the I3C link. An in-band interrupt (IBI) handling module may be always on (e.g., be on while the host controller is in the low-power mode. In such fashion, power consumption may be reduced as the host controller or parts of the host controller are allowed to enter the low-power mode.

Moreover, the master may include one or more processing units (e.g., at least one CPU), including a manager processing unit (e.g., a manger CPU). The IBI handling module may be configured to select and to wake up one of the processing units to which an IBI is directed. In such fashion, the master does not need for the manager processing unit to stay awake to process the IBI request, and power consumption may be reduced further.

Moreover still, the IBI handling module may be configured to issue an initial processing unit interrupt (e.g., to wake up) the one or more processing units after receiving multiple IBI requests. The IBI handling module may issue multiple processing unit interrupts out of order with which corresponding IBI requests are received. In such fashion, detecting the IBI requests and responding to the IBI requests are disassociated from issuing the multiple processing unit interrupts. Such flexibility improves performance of IBI handling.

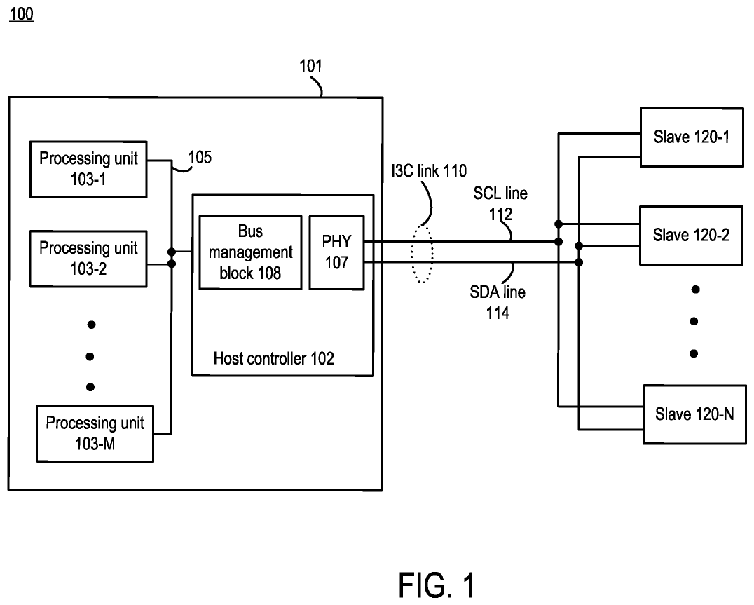

FIG. 1 illustrates components of an apparatus having an I3C link. The apparatus 100 may, for example, be one of a computing system (e.g., servers, datacenters, desktop computers), mobile computing device (e.g., laptops, cell phones, vehicles, etc.), Internet of Things device, and virtual reality or augmented reality system. The apparatus 100 includes a master 101 (e.g., master device), an I3C link 110, and at least one slave 120-1 to 120-N (e.g., slave devices). The master 101 may be, for example, an application processor that performs various functions (e.g., telephony, wireless data access, audio/video function, etc.) and communicates with the at least one slave 120-1 to 120-N via the I3C link 110, in a mobile device. The I3C link 110 includes a Serial Clock (SCL) line 112 and a Serial Data (SDA) line 114.

The master 101 includes at least one processing unit (one or more) 103-1 to 103-M, a host controller 102, and a bus system 105. The bus system 105 may be one or more buses and may directly or indirectly connect the at least one processing unit 103-1 to 103-M to the host controller 102. In one example, the host controller 102 may be configured to handle communications on the I3C bus 110 in accordance with a MIPI Alliance specification (e.g., configured to operate the I3C link meeting all requirements of the MIPI specification). The host controller 102 includes a PHY 107 and a bus management block 108. The PHY 107 may be configured to control/operate an I3C signaling physical layer in accordance with the MIPI Alliance specification. For example, the PHY 107 may include an IBI detector configured to detect an IBI request on the I3C link 110. The bus management block 108 may be configured to control logics of I3C signaling in accordance with the MIPI specification. For example, the bus management block 108 may include configuration registers, data packet generator, and an IBI manager (not shown for clarity).

The at least one processing unit 103-1 to 103-M may be, for example, central processing unit (CPU), including a manager CPU. For example, the processing unit 103-1 may be the manager processing unit or manager CPU. That is, the processing unit 103-1 may stay awake to perform certain functions while the other processing units (e.g., 103-2 to 103-M) are in a low-power mode. In some examples, the at least one processing unit 103-1 to 103-M may be functional unit or units for performing various functions (e.g., telephony, wireless data access, audio/video function, etc.). For example, in a mobile device, the at least one processing unit 103-1 to 103-M may include a modem, an image signal processor, and/or multimedia modules. The at least one slave (e.g., one or more) 120-1 to 120-N may be, for example, various sensors. For example, the at least one slave 120-1 to 120-N may include a fingerprint sensor, a capacitive touch sensor, and/or a camera.

The aforementioned modules of the master 101 may enter into a low-power mode to save power (e.g. when the master 101 is not in active operation). For example, the at least one processing unit 103-1 to 103-M may be configured to enter the low-power mode. The low-power mode may be a sleep mode where the component is power down. However, the host controller 102 cannot enter into the low-power mode because the host controller 102 may need to remain powered on to handle an IBI event on the I3C link 110.

In an event that one of the at least one slave 120-1 to 120-N issues an IBI request on the I3C link 110 (e.g., pulling the SDA 114 line Low or logic 0), the host controller 102 (e.g., the bus management block 108 and the PHY 107) may operate to detect the IBI request on the SDA line 114 and to respond to the IBI request. For example, the host controller 102 may respond to the detected IBI request by clocking the SCL line 112 to receive information of the IBI request from the requesting at least one slave 120-1 to 120-N. The host controller 102 may further respond to the detected IBI request by relinquishing the I3C link 110 (e.g., placing the I3C link 110 in an idle state ready for a subsequent IBI event).

The host controller 102 may, in response to the detected IBI request, signal a processing unit interrupt to the at least one processing unit 103-1 to 103-M via the bus system 105. The processing unit interrupt may, for example, wake up the manager processing unit 103-1 from the low-power mode. The host controller 102 may further provide the information of the IBI request to the manager processing unit 103-1. The manager processing unit 103-1 may determine to which of the at least one processing unit 103-1 to 103-M the IBI request is directed. The manager processing unit 103-1 may then wake up another one of the at least one processing unit 103-1 to 103-M via the bus system 105, based on the information of the IBI request.

For example, the information of the IBI request may indicate that the IBI request is directed at the processing unit 103-2. The manager processing unit 103-1 may issue a processing unit interrupt, via the bus system 105, to wake up the processing unit 103-2. The processing unit 103-2 may perform operations in accordance with the IBI request (e.g., to service the IBI request). Upon completion of these operations, the processing unit 103-2 may inform the host controller 102 via the bus system 105 to relinquish the I3C link 110.

Subsequently, the host controller 102 may detect a second IBI request, and the manager processing unit 103-1 may signal a second processing unit interrupt as presented above. The manager processing unit 103-1 may signal the processing unit interrupt and the second processing unit interrupt in an order of the IBI requests detected.

Since the host controller 102 does not go into a low power mode, power is consumed just to wait for an IBI request. Further, to wake up a manager processing unit and then a second processing unit of the at least one processing unit 103-1 to 103-M requires additional power and time. Further, signaling a processing unit interrupt and signaling a second processing unit in an order of detected IBI requests lack flexible and reduce performance. An IBI-handling scheme with improved power, performance, and flexibility is presented below.

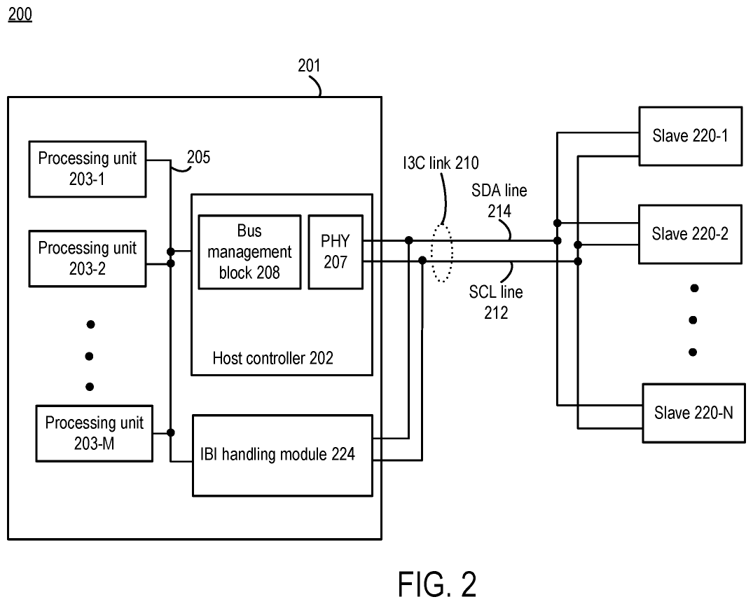

FIG. 2 illustrates an apparatus having an I3C link, in accordance with certain aspects of the disclosure. The apparatus 200 may, for example, be one of a computing system (e.g., servers, datacenters, desktop computers), mobile computing device (e.g., laptops, cell phones, vehicles, etc.), Internet of Things device, and virtual reality or augmented reality system. FIG. 2 includes a master 201 (e.g., master device), an I3C link 210, and/or at least one slave 220-1 to 220-N (e.g., slave devices). The master 201 may be, for example, an application processor that performs various functions (e.g., telephony, wireless data access, audio/video function, etc.) and communicates with the at least one slave 220-1 to 220-N via the I3C link 210, in a mobile device. The I3C link 210 includes a serial clock (SCL) line 212 and a serial data (SDA) line 214.

The I3C link 210 may be an instance of the I3C link 110 of FIG. 1. The SCL line 212 may be an instance of the SCL line 112 of FIG. 1. The SDA line 214 may be an instance of the SDA line 114 of FIG. 1. The at least one slaves (e.g., one or more) 220-1 to 220-N may be an instance (or instances) of the at least one slave 120-1 to 120-N. The master 201 includes at least one processing unit (e.g., one or more) 203-1 to 203-M, a host controller 202, a bus system 205, and an IBI handling module 224. The at least one processing unit 203-1 to 203-M may be an instance (or instances) of the at least one processing unit 103-1 to 103-M of FIG. 1. The host controller 202 may be an instance of the host controller 102 of FIG. 1. For example, the host controller 202 may be configured comply with requirements of a MIPI Alliance specification to operate the I3C link 210. The host controller 202 may be configured to communicate with the at least one slave 220-1 to 220-N via the I3C link 210 and configured to enter into a low-power mode. The bus system 205 may be an instance of the bus system 105 of FIG. 1.

The IBI handling module 224 may be configured to always on. For example, the IBI handling module 224 may remain on to detect, respond, and/or issue a processing unit interrupt while the host controller 202 or both the host controller 202 and the at least one processing unit 203-1 to 203-M are in a low-power mode. Since the IBI handling module 224 (being dedicated to handle only IBIs) is limited in functions compared to the host controller 202, the IBI handling module 224 may consume less power than the host controller 202. In such fashion, power consumption is reduced by allowing the host controller 202 to enter the low-power mode, while keeping the IBI handling module 224 powered on. Moreover, the IBI handling module 224 may issue the processing unit interrupt to wake up the one processing unit of the at least one processing unit 203-1 to 203-M to which a detected IBI requested is directed. Thus, power consumption may be further reduced by not waking up a manager processing unit of the at least one processing unit 203-1 to 203-M.

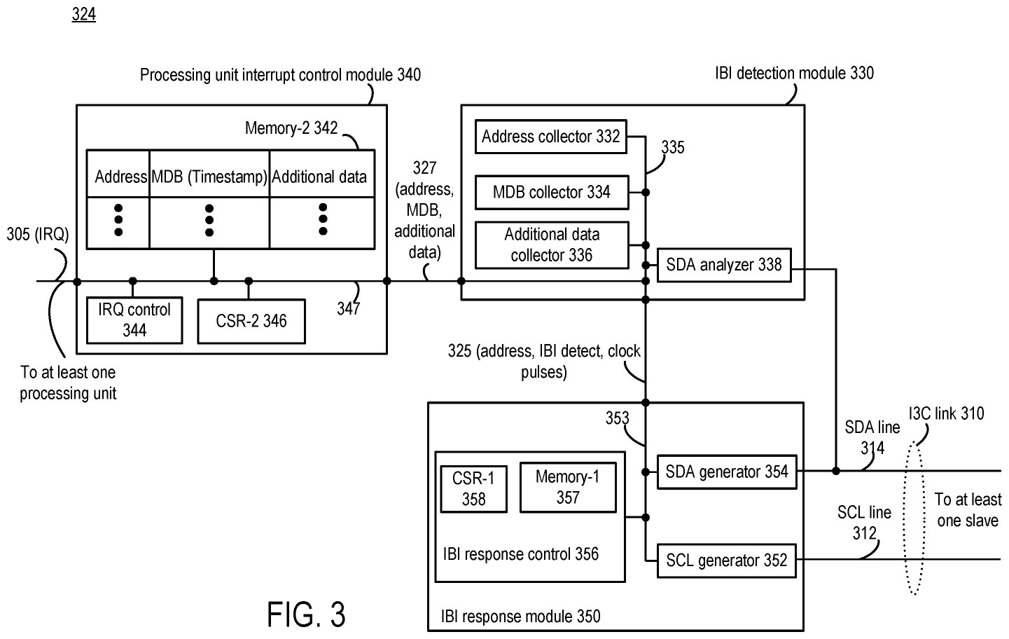

FIG. 3 illustrates an IBI handling module of FIG. 2. The IBI handling module 324 may be an instance of the IBI handling module 224 of FIG. 2. FIG. 3 includes a bus system 305, an I3C link 310, a bus system 325, a bus system 327, a bus system 329, an IBI detection module 330, a processing unit interrupt control module 340, and an IBI response module 350. The bus system 305 may be an instance of the bus system 205, and the I3C link 310 may be an instance of the I3C link 210 of FIG. 2. The I3C link 310 includes an SDA line 314 (e.g., an instance of the SDA line 214 of FIG. 2) and an SCL line 312 (e.g., an instance of the SCL line 212 of FIG. 2). The IBI handling module 324 is coupled to at least one slave (e.g., the at least one slave 220-1 to 220-N of FIG. 2) via the I3C link 310 and to at least one processing unit (e.g., the at least one processing unit 203-1 to 203-M of FIG. 2) via the bus system 305. The bus system 335 couples the address collector 332, the MDB collector 334, the additional data collector 336, and the SDA analyzer 338. The bus system 335 further couples to the bus system 325 and to the bus system 327.

The IBI handling module 324 may be configured to detect an IBI request on the I3C link 310 (specifically, on the SDA line 314), to respond to the IBI request, and/or to issue a processing unit interrupt to one of the at least one processing unit to which the IBI request is directed. Various components are presented as examples to perform some or all of these functions.

The IBI detection module 330 may be configured to detect while the host controller (e.g., the host controller 202 of FIG. 2) is in a low-power mode, on the SDA line 314 line, an in-band interrupt (IBI) request from the at least one slave. The IBI detection module 330 may include some or all of an address collector 332, a mandatory data byte (MDB) collector 334, a bus system 335, an additional data collector 336, and/or an SDA analyzer 338. The IBI detection module 330 is coupled to the IBI response module 350 via the bus system 325 and coupled to the processing unit interrupt control module 340 via the bus system 327. The SDA analyzer 338 may be configured to determine states on the SDA line 314 and/or to detect an IBI request. For example, in a case the I3C link 310 is in a Bus Available Condition (both SDA line 314 and SCL line 312 are High or logic 1), one of the at least one slave may pull the SDA line 314 Low to signal an IBI request. The SDA analyzer 338 may recognize the SDA line 314 being pulled Low and thereby detects the IBI request. The SDA analyzer 338 may provide an IBI detect signal to the IBI response module 350 via the bus system 335 and the bus system 325 and to the processing unit interrupt control module 340 via the bus system 335 and the bus system 327.

The IBI response module 350 may operate to receive information of the IBI request (e.g., IBI data, mandator data byte, Device Address) on the I3C link 310. Further details are presented below with the IBI response module 350. The address collector 332 and the MDB collector 334 are coupled to the SDA analyzer 338 via the bus system 335. The address collector 332 may be configured to recognize the data inputted on the SDA line 314, detected by the SDA analyzer 338, as an address of the one of the at least one slave issuing the IBI request (e.g., Device Address). The address collector 332 may further be configured to store the address. The address collector 332 may provide the address of the one of the at least one slave issuing the IBI request to the IBI response module 350 via the bus system 335 and the bus system 325 and to the processing unit interrupt control module 340 via the bus system 335 and the bus system 327.

The MDB collector 334 may be configured to recognize the data inputted on the SDA line 314, detected by the SDA analyzer 338, as the MDB of the IBI request. The MDB collector 334 may be further configured to store the MDB. The MDB may be a first byte of IBI data provided by the requesting at least one slave and may be part of the information of the IBI request. The MDB may include a timestamp (e.g., provided by the one of the at least one slave issuing the IBI request). The MDB collector 334 may provide the MDB of the IBI request to the processing unit interrupt control module 340 via the bus system 335 and the bus system 327.

Further, the additional data collector 337 may be configured to recognize and/or store additional data of the IBI request on the SDA line 314, as part of the information of the IBI request. The additional data may be data provided by the request at least one slave, following the MDB. Moreover, the additional data may be based on a private contract between a master and a requesting at least one slave. The additional data collector 337 may provide the additional data to the processing unit interrupt control module 340 via the bus system 335 and the bus system 327.

The IBI response module 350 may be configured to operate the I3C link 310 to respond to the at least one slave, in response to the IBI detection module 330 detecting the IBI request, in the case the host controller (e.g., the host controller 202 of FIG. 2) is in the low-power mode. The IBI response module 350 may include some or all of an SCL generator 352, an SDA generator 354, an IBI response control 356, and a bus system 353. The bus system 353 couples the SCL generator 352, the SDA generator 354, the IBI response control 356 and couples to the bus system 325. The SCL generator 352 may be configured to operate (e.g., to drive or to leave open) the SCL line 312. The SDA generator 354 may be configured to operate (e.g., to drive or to leave open) the SDA line 314. The IBI response control 356 may be configured to control operations of the SCL generator 352 and the SDA generator 354.

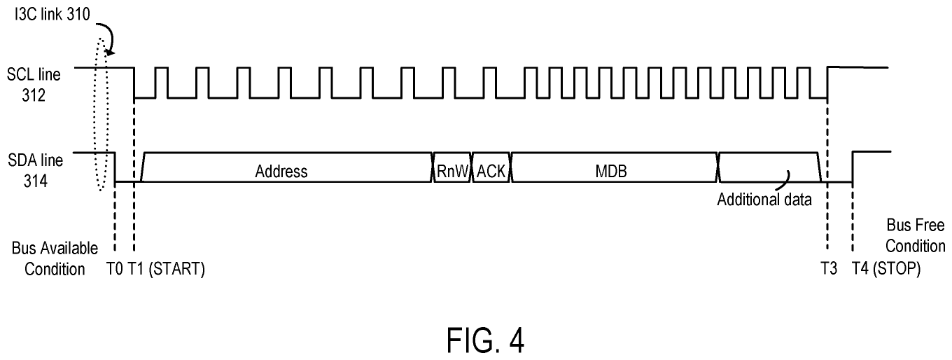

Operations of the IBI response module 350 is presented with FIG. 3 and FIG. 4. FIG. 4 illustrates a waveform diagram of an IBI request and response. FIG. 4 includes signaling of the I3C link 310 during an IBI event. Initially (before T0), the I3C link 310 is in a Bus Available State (e.g., both the SCL line 312 and the SDA line 314 are High). At T0, one of the at least one slave coupled to the I3C link 310 pulls Low the SDA line 314 to signal an IBI request. The IBI detection module 330 (via the SDA analyzer 338) may detect that the SDA line 314 is pulled Low and recognize the IBI request. The IBI detection module 330 may issue an IBI detect signal to the IBI response module 350, via the bus system 325.

At T1, in response to receiving the IBI detect signal from the IBI detection module 330, the IBI response control 356 may direct the SCL generator 352 to pull the SCL line 312 Low to complete a START Condition. In response to the completion of the START Condition, the one of the at least one slave may output onto the SDA line 314 its 7-bit address (Device Address) and 1-bit RnW (read or write) bit. Subsequently, the IBI response module 350 may provide an ACK bit to the one of the at least one slave issuing the IBI request to indicate acceptance of the IBI request. Accordingly, the IBI response module 350 may be configured to respond to the at least one slave (issuing the IBI request), via the SCL generator 352, by clocking the SCL line 312 to read the information of the IBI request (e.g., 7 address bits, 1 RnW bit), in the case the host controller (e.g., the host controller 202 of FIG. 2) is in the low-power mode. The IBI response module 350 may be further configured to respond to the at least one slave, via the SDA generator 354, by operating the I3C link 310 to acknowledge the IBI request (e.g., providing the ACK).

For example, the IBI response control 356 may direct the SCL generator 352 to generate 9 clock pulses onto the SCL line 312 (e.g., the 9 clock pulses include 7 address bits, 1 RnW bit, and 1 ACK bit). The IBI response module 350 may provide the clock pulses to the IBI detection module 330 via the bus system 325. For example, the address collector 332 may utilize the received clock pluses to extract the address from the SDA line 314. The IBI response control 356 may also direct the SDA generator 354 to output the ACK bit onto the SDA line 314.

In response to the ACK bit to the IBI request, the at least one slave issuing the IBI request may output a mandatory data byte (MDB) onto the SDA line 314. If enabled, information of an IBI request would include at least the MDB. The MDB may include a timestamp of the IBI request. The IBI response control 356 may direct the SCL generator 352 to generate 8 clock pulses onto the SCL line 312 to read in the MDB. The IBI response module 350 may provide the clock pulses to the IBI detection module 330 via the bus system 325. For example, the MDB collector 334 may utilize the received clock pluses to extract the MDB from the SDA line 314.

In addition to the address of the at least one slave (Device Address) and the MDB (e.g., timestamp), the information of the IBI request may further include additional data. In FIG. 4, four additional bits after the MDB are shown as the additional data. The amount of additional data may be based on a private contract between the master and the at least one slave issuing the IBI request.

The IBI response control 356 may include a memory-1 357 and/or a configuration status register CSR-1. The memory-1 357 may be configured to store information of the IBI request. For example, the memory-1 357 may store a table of the private contract between the master and the at least one slave, searchable by the address of the at least one slave. Such private contracts may be referred to as IBI contexts. The address collector 332 may provide the address of the at least one slave (Device Address) to the IBI response control 356 via the bus system 325 and the bus system 353. The IBI response control 356 may use the address of the at least one slave to search for the private contract within the memory-1 357.

The table of the private contracts (e.g., IBI contexts) may be further governed by the CSR-1 358. Various aspects of the search result may be adjusted by the CSR-1 358. For example, the CSR-1 358 may disallow or limit reading in certain additional data as security measures. The IBI response control 356 may, based on the private contract found, directed the SCL generator 352 to generate a number clock pulses onto the SCL line 312 to read in the additional data.

At T3, after reading in the additional data (as well as address of the at least one slave device and the MDB), the SCL line 312 is pulled High. AT T4, the SDA line 314 is pulled High to complete a STOP condition. For example, the IBI response control 356 may direct the SCL generator 352 and/or the SDA generator 354 to pull the SCL line 312 and/or the SDA line 314 High, in a case the reading of the additional data is completed. Upon STOP, the I3C link 310 enters a Bus Free Condition (a predecessor of the Bus Available Condition). In such fashion, the MI response module 350 may be configured to respond to the at least one slave requesting the IBI, via the SCL generator 352 and/or the SDA generator 354, by relinquishing the I3C link 310.

Referring to FIG. 3, the processing unit interrupt control module 340 is configured to signal a processing unit interrupt (e.g., an IRQ signal) to the at least one processing unit based on information of the IBI request, while the host controller (e.g., the host controller 202 of FIG. 2) is in the low-power mode, in response to the IBI detection module 330 detecting the IBI request. The processing unit interrupt control module 340 include may include some or all of a memory-2 342, an IRQ control module 344, a configuration and status register CSR-2 346, and/or a bus system 347. The bus system 347 couples the memory-2 342, the IRQ control module 344, and the CSR-2 346 and couples to the bus system 305 and to the bus system 327.

The memory-2 342 may include a volatile memory or a non-volatile memory and may be configured to store information of the IBI request. For example, the information of the IBI request may include an address of the at least one slave (e.g., the requesting slave) and at least a portion of the MDB (e.g., timestamp) of the IBI request detected by the IBI detection module 330. The information of the IBI request may be received from the IBI detection module 330 via the bus system 327 and the bus system 347. For each IBI request, the information of the IBI request may include address (e.g., DA; the address of the at least one slave issuing the IBI request), MDB (including a timestamp of the IBI request), and/or additional data. Information of more than one IBI requests may be received and stored.

The processing unit interrupt control module 340 may be configured to signal a processing unit interrupt based on the information of the IBI request stored in the memory-2 342, via the IRQ control module 344. The IRQ control module 344 may be configured to select one of the at least one processing unit (e.g., at least one processing unit 203-1 to 203-M of FIG. 2) and issue thereto the processing unit interrupt (IRQ) via the bus system 347 and the bus system 305. The IRQ control module 344 may be configured to select the one of the at least one processing unit based in information of the IBI requests stored in the memory-2 342. For example, the IRQ control module 344 may search the memory-2 342 by address (e.g., DA; address of the at least one slave issuing the IBI request), by the MDB (e.g., timestamp), or by the additional data. The IRQ control module 344 may select the one of the at least one processing unit based on time (e.g., timestamps of the IBI requests) or urgency determined in the stored information of the IBI requests. For example, a panic mode IBI request (e.g., indicated by the stored additional data) may be selected before other IBI requests. In such fashion, the IRQ control module 344 may signal the IRQs to different ones of the at least one processing unit out of order with respect to an order of the IBI detection module 330 detecting and receiving corresponding IBI requests.

The selection may further be modified by the CSR-2 346. A master (e.g., master 201 of FIG. 2) may modify the IRQ control module 344 selecting the one of the at least one processing unit via the CSR-2 346. For example, as security measures, the CSR-2 346 may cause the IRQ control module 344 to select certain ones of the at least one processing unit ahead of others or disallowing the IRQ control module 344 from selecting certain ones of the at least one processing unit.

In some examples, the processing unit interrupt control module 340 may be configured to signal an initial processing unit interrupt (IRQ) to the at least on processing unit, in response to the IBI detection module 330 detecting one of the plurality of IBI requests, after the IBI detection module 330 detects a plurality of IBI requests. For example, the IBI detection module 330 could detect and read in multiple IBI requests (more than one), and the memory-2 342 could store information of the multiple IBI request. The processing unit interrupt control module 340 may issue an initial processing unit interrupt (e.g., first among IRQs caused by the multiple IBI request) after the IBI detection module 330 detects the multiple IBI requests and/or after the memory-2 storing the information of the multiple IBI requests. Because the memory-2 stores information of the multiple IBI requests, the IBI detection module 330 and the IRQ control module 344 may operate in a non-sequential fashion. The IRQ control module 344 may thus signal IRQs to the at least one processing unit out of order with respect an order of the IBI detection module 330 detecting the multiple IBI requests.

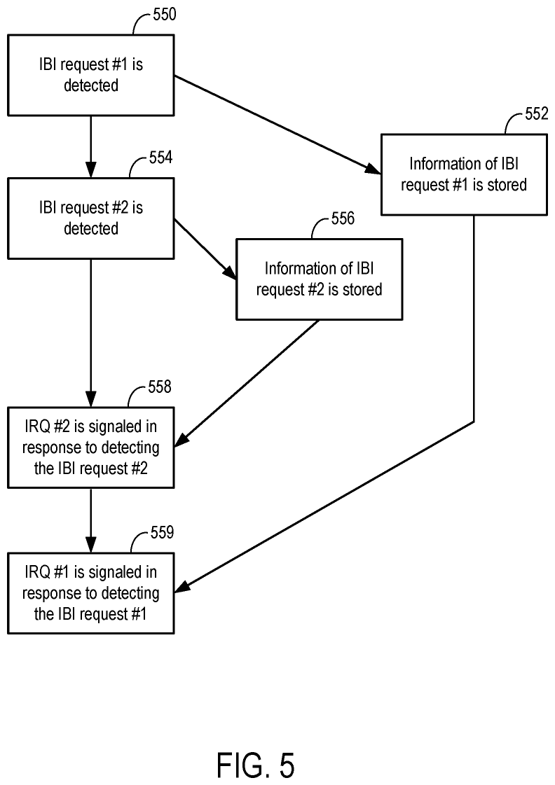

FIG. 5 illustrates out of order signaling of processing unit interrupts. For FIG. 5 only, arrows illustrate a timing relationship. In some examples, operations of FIG. 5 may be performed while some or all of the host controller 202 and the at least one processing unit 203-1 to 203-M are in a low-power mode. At 550, IBI request #1 is detected. For example, the IBI detection module 330 (e.g., the SDA analyzer 338; FIG. 3) detects the IBI request #1 on the SDA line 314 (FIG. 3). At 552, subsequent to 550, information of IBI request #1 is stored. For example, the memory-2 340 (FIG. 3) stores the information of IBI request #1, such as an address of a slave, a MDB of the IBI request #1, and additional data of the IBI request #1. AT 554, subsequent to 550, IBI request #2 is detected. For example, the IBI detection module 330 (e.g., the SDA analyzer 338) detects the IBI request #2 on the SDA line 314. At 556, subsequent to 554, information of IBI request #2 is stored. For example, the memory-2 340 stores the information of IBI request #2. Accordingly, the memory-2 340 is configured to store information of the multiple IBI requests (e.g., the information of IBI request #1 and the information of IBI request #2). The information of the multiple IBI requests may include addresses of the at least one slave that issued the multiple IBI requests, MDBs (e.g., timestamps) of the multiple IBI requests, and/or additional data of the multiple IRQ requests.

At 558, subsequent to 554 and/or 556, a processing unit interrupt IRQ #2 is signaled in response to detecting the IBI request #2. For example, the processing unit interrupt control module 340 (e.g., IRQ control module 344; FIG. 3) signals the IRQ #2 to the at least one processing unit via the bus system 305 (FIG. 3) based on the information of IBI request #2, in response to the IBI detection module 330 detecting the IBI request #2. At 559, subsequent to 558 and/or 552, a processing unit interrupt IRQ #1 is signaled in response to detecting the IBI request #1. For example, the processing unit interrupt control module 340 signals the IRQ #1 to the at least one processing unit via the bus system 305 based on the information of IBI request #1, in response to the IBI detection module 330 detecting the IBI request #1.

As presented above, the processing unit interrupt control module 340 (e.g., IRQ control module 344) may be configured to signal the initial or first processing unit interrupt (e.g., IRQ #2) to the at least on processing unit, in response to the IBI detection module 330 detecting one of the multiple IBI requests (e.g., detecting the IBI request #2 of the IBI request #1 and the IBI request #2), after the IBI detection module 330 detects multiple IBI requests (e.g., the IBI request #1 and the IBI request #2). The processing unit interrupt control module 340 may signal the initial or first processing unit interrupt (e.g., IRQ #2) based on the information of the one (e.g., IRQ request #2) of the multiple IBI requests, such as an address of the at least one slave issuing IRQ request #2 and at least a portion of the MDBs, such as the timestamp of the one (e.g., IRQ request #2) of the multiple IBI requests.

The processing unit interrupt control module 340 may be further configured to signal a second processing unit interrupt (e.g., IRQ #1) to the at least on processing unit, in response to the IBI detection module 330 detecting a second one of the multiple IBI requests (e.g., detecting IBI request #1 of the IBI request #1 and the IBI request #2). The initial processing unit interrupt (e.g., IRQ #2) and the second processing unit interrupt (e.g., IRQ #1) may be signaled not in an order of the IBI detection module 330 detecting the one (e.g., IBI request #2) and the other one (e.g., IBI request #1) of the multiple IBI requests. For example, the IBI detection module 330 may detect the second one (e.g., detecting IBI request #1 at 550) of the multiple IBI requests before detecting the one (e.g., detecting IBI request #2 at 554) of the multiple IBI requests, and the processing unit interrupt control module 340 may signal the initial or first processing unit interrupt (e.g., IRQ #2 at 558) to the at least on processing unit before signal the second processing unit interrupt (e.g., IRQ #1 at 559).

Further, the IBI response module 350 may be configured to operate the I3C link to respond to the at least one slave that issued the IBI request to the one (e.g., IBI request #2) of the multiple IBI requests, in response to the IBI detection module detecting the one (e.g., IBI request #2) of the multiple of IBI requests. The IBI response module 350 may be further configured to respond to the at least one slave by clocking the SCL line 312 to read the information of the one (e.g., IBI request #2) of the multiple of IBI requests. The IBI response module 350 may be further configured to respond to the at least one slave by operating the I3C link to acknowledge the one (e.g., IBI request #2) of the multiple of IBI request and to relinquish the I3C link (see FIG. 4 and the associated description).

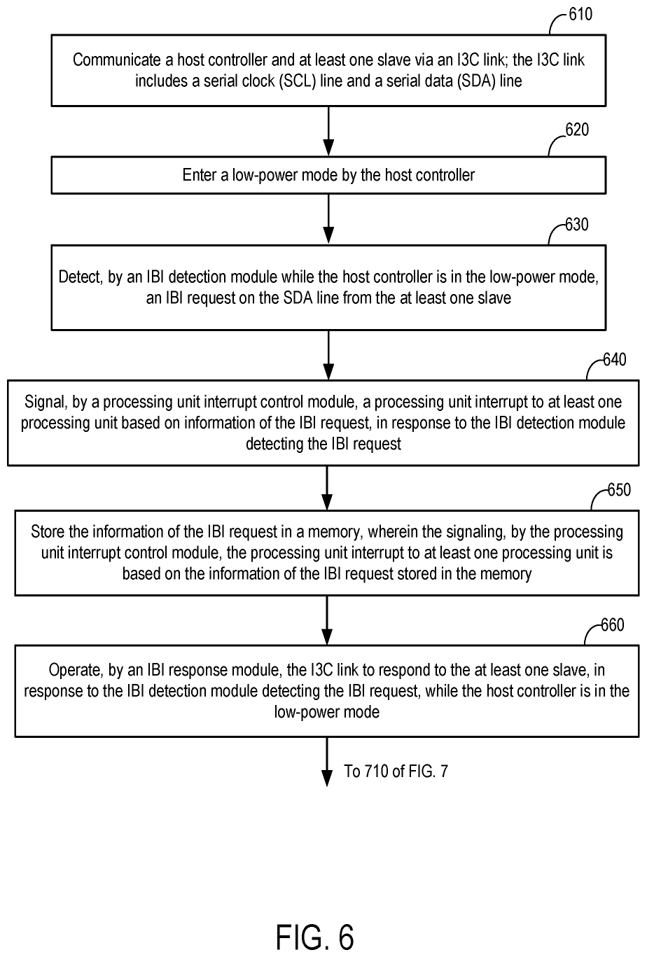

FIG. 6 illustrates a first portion of a method for IBI handling in a low-power mode. The operations of FIG. 6 may be implemented by, for example, the apparatus 200 presented with FIGS. 2, 3, 4, and/or 5. The arrows indicate certain relationships among the operations, but not necessarily sequential relationships.

At 610, a host controller and at least one slave are communicated via an I3C link. The I3C link includes a serial clock (SCL) line and a serial data (SDA) line. For example, referring to FIG. 2, the host controller 202, integrated within the master 201, communicates with at least one slave 220-1 to 220-N via the I3C link 210. The I3C link 210 includes the SCL line 212 and the SDA line 214. In some examples, the host controller 202 complies with a MIPI Alliance I3C specification to operate the communication over the I3C link 210. In some examples, the host controller 202 detects IBI requests from the at least one slave 220-1 to 220-N at least on the SDA line 214. The host controller 202 further responds to the IBI requests by acknowledging the IBI requests and relinquishing the I3C link 210 to allow the at least one slave 220-1 to 220-N to enter more IBI requests on the SDA line 214.

At 620, a low-power mode is entered by the host controller. For example, referring to FIG. 2, the host controller 202 enters into a low-power mode such as sleep mode. In some examples, the host controller 202 is powered down for the low-power mode. At 630, an IBI request from the at least one slave is detected by an IBI detection module on the SDA, while the host controller is in the low-power mode. For example, referring to FIG. 3 and FIG. 4, in a case the I3C link is in a Bus Available Condition (both SDA line 314 and SCL line 312 are High), one of the at least one slave pulls the SDA line 314 Low to signal an IBI request. The SDA analyzer 338 recognizes the SDA line 314 being pulled Low and thereby detects the IBI request. The SDA analyzer 338 provides an IBI detect signal to the IBI response module 350 (via the bus system 335 and the bus system 325) and to the processing unit interrupt control module 340 (via the bus system 335 and the bus system 327).

At 640, a processing unit interrupt is signaled, by a processing unit interrupt control module, to at least one processing unit, based on information of the IBI request. The processing unit interrupt control module signals the processing unit interrupt in response to the IBI detection module detecting the IBI request, while the host controller is in the low-power mode. For example, referring to FIG. 3, the IRQ control module 344 selects one of the at least one processing unit (e.g., at least one processing unit 203-1 to 203-M) and issues thereto the processing unit interrupt (IRQ) via the bus system 347 and the bus system 305.

At 650, the information of the IBI request is stored in a memory. The processing unit interrupt is signaled, by the processing unit interrupt control module, to at least one processing unit based on the information of the IBI request stored in the memory. For example, referring to FIG. 3, the information of the IBI request is received from the IBI detection module 330 via the bus system 327 and the bus system 347 and is stored in the memory-2 342. For each IBI request, the information of the IBI request includes address (e.g., DA; the address of the at least one slave issuing the IBI request), MDB (including timestamp of the IBI request), and/or additional data. Information of more than one IBI requests may be received and stored. Further, see the example provided with 640.

At 660, the I3C link is operated by an IBI response module to respond to the at least one slave, in response to the IBI detection module detecting the IBI request, while the host controller is in the low-power mode. For example, referring to FIG. 3 and FIG. 4, the IBI response module 350 operates the I3C link to respond (e.g., to ACK an IBI request and/or to relinquish the I3C bus by putting the I3C bus in a Bus Free Condition).

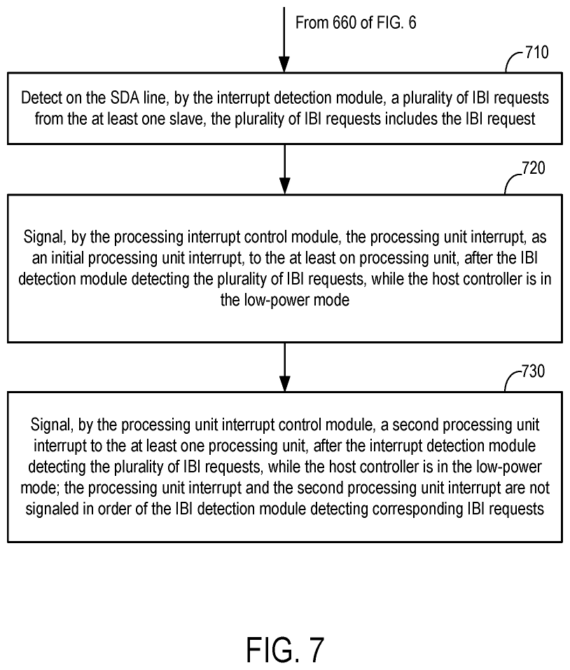

The method of FIG. 6 may continue at 710 of FIG. 7. FIG. 7 illustrates a second portion of the method for IBI handling in a low-power mode of FIG. 6. The operations of FIG. 7 may be implemented by, for example, the apparatus 200 presented with FIGS. 2, 3, 4, and/or 5. The arrows indicate certain relationships among the operations, but not necessarily sequential relationships.

At 710 (which may follow 660), a plurality of IBI requests from the at least one slave is detected, by the interrupt detection module, on the SDA line. The plurality of IBI requests includes the IBI request. For example, referring to FIG. 3, the SDA analyzer 338 detects more than one IBI requests (e.g., from different ones of the at least on slave) on the SDA line 314. Referring to FIG. 5, the IBI request #1 and the IBI request #2 are detected.

At 720, the processing unit interrupt is signaled as an initial processing unit interrupt, by the processing interrupt control module, to the at least on processing unit, after the IBI detection module detecting the plurality of IBI requests, while the host controller is in the low-power mode. For example, referring to FIG. 5, the processing interrupt control module 340 (via the IRQ control module 344; FIG. 3) signals the IRQ #2 to the at least on processing unit (e.g., target of the IRQ #2) as an initial processing unit interrupt, after the IBI detection module 330 (FIG. 3) detects the plurality of IBI requests (e.g., IRQ #1 and IRQ #2) and while the host controller 202 (FIG. 2) is in the low-power mode.

At 730, a second processing unit interrupt is signaled, by the processing unit interrupt control module, to the at least one processing unit, after the interrupt detection module detecting the plurality of IBI requests, while the host controller is in the low-power mode. The processing unit interrupt and the second processing unit interrupt are not signaled in order of the IBI detection module detecting corresponding IBI requests. For example, referring to FIG. 5, the processing interrupt control module 340 (via the IRQ control module 344; FIG. 3) signals the IRQ #1 to the at least on processing unit (e.g., target of the IRQ #1) as the second processing unit interrupt, after the IBI detection module 330 (FIG. 3) detects the plurality of IBI requests (e.g., IRQ #1 and IRQ #2) and while the host controller 202 (FIG. 2) is in the low-power mode. The processing unit interrupt IRQ #2 and the second processing unit interrupt IRQ #1 are not signaled in order of the IBI detection module 330 (FIG. 3) detecting corresponding IBI requests (e.g., the IBI detection module 330 detects the IBI request #1, corresponding to the IRQ #1, before detecting the IBI request #2, corresponding to the IRQ #2).

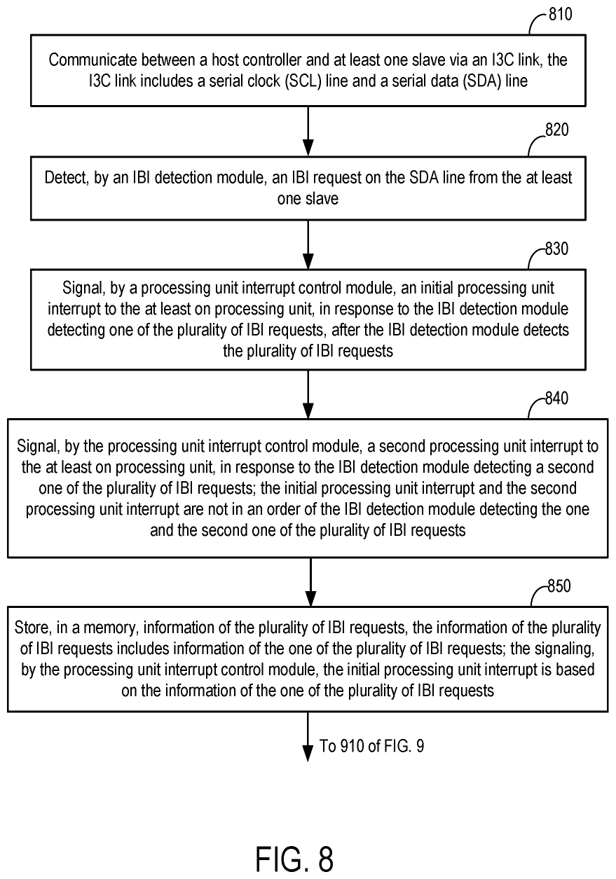

FIG. 8 illustrates a first portion of a method for IBI handling. The operations of FIG. 8 may be implemented by, for example, the apparatus 200 presented with FIGS. 2, 3, 4, and/or 5. The arrows indicate certain relationships among the operations, but not necessarily sequential relationships.

At 810, a host controller and at least one slave are communicated via an I3C link. The I3C link includes a serial clock (SCL) line and a serial data (SDA) line. For example, referring to FIG. 2, the host controller 202, integrated within the master 201, communicates with at least one slave 220-1 to 220-N via the I3C link 210. The I3C link 210 includes the SCL line 212 and the SDA line 214. In some examples, the host controller 202 complies with a MIPI Alliance I3C specification to operate the communication over the I3C link 210. In some examples, the host controller 202 detects IBI requests from the at least one slave 220-1 to 220-N on the SDA line 214. The host controller 202 further responds to the IBI requests by acknowledging the IBI requests and relinquishing the I3C link 210 to allow the at least one slave 220-1 to 220-N to enter more IBI requests on the SDA line 214.

At 820, an IBI request from the at least one slave is detected by an IBI detection module on the SDA line. For example, referring to FIG. 3 and FIG. 4, in a case the I3C link is in a Bus Available Condition (both SDA line 314 and SCL line 312 are High), one of the at least one slave pulls the SDA line 314 Low to signal an IBI request. The SDA analyzer 338 recognizes the SDA line 314 being pulled Low and thereby detects the IBI request. The SDA analyzer 338 provides an IBI detect signal to the IBI response module 350 (via the bus system 335 and the bus system 325) and to the processing unit interrupt control module 340 (via the bus system 335 and the bus system 327).

At 830, an initial processing unit interrupt is signaled, by a processing unit interrupt control module, to the at least on processing unit, in response to the IBI detection module detecting one of the plurality of IBI requests, after the IBI detection module detects the plurality of IBI requests. For example, referring to FIG. 5, the processing interrupt control module 340 (via the IRQ control module 344; FIG. 3) signals the IRQ #2 to the at least on processing unit (e.g., target of the IRQ #2) as an initial processing unit interrupt, after the IBI detection module 330 (FIG. 3) detects the plurality of IBI requests (e.g., the IBI request #1 and the IBI request #2).

At 840, a second processing unit interrupt is signaled, by the processing unit interrupt control module, to the at least on processing unit, in response to the IBI detection module detecting a second one of the plurality of IBI requests. The initial processing unit interrupt and the second processing unit interrupt are not in an order of the IBI detection module detecting the one and the second one of the plurality of IBI requests. For example, referring to FIG. 5, the processing interrupt control module 340 (via the IRQ control module 344; FIG. 3) signals the IRQ #1 to the at least on processing unit (e.g., target of the IRQ #1) as the second processing unit interrupt, after the IBI detection module 330 (FIG. 3) detects the plurality of IBI requests (e.g., the IBI request #1 and the IBI request #2). The processing unit interrupt IRQ #2 and the second processing unit interrupt IRQ #1 are not signaled in an order of the IBI detection module 330 (FIG. 3) detecting corresponding IBI requests (e.g., the initial IRQ #2 is signaled first, while the corresponding IBI request #2 is detected second).

At 850, information of the plurality of IBI requests, is stored in a memory. The information of the plurality of IBI requests includes information of the one of the plurality of IBI requests. The signaling, by the processing unit interrupt control module, the initial processing unit interrupt is based on the information of the one of the plurality of IBI requests. For example, referring to FIG. 3, the information of the IBI requests (e.g., IBI request #1 and IBI request #2 of FIG. 2) is received from the IBI detection module 330 via the bus system 327 and the bus system 347 and is stored in the memory-2 342. For each IBI request, the information of the IBI request includes address (e.g., DA; the address of the at least one slave issuing the IBI request), MDB (including timestamp of the IBI request), and/or additional data. Information of more than one IBI requests may be received and stored. Further, see the example provided with 640. the IRQ control module 344 selects one of the at least one processing unit (e.g., at least one processing unit 203-1 to 203-M) and issues thereto the processing unit interrupt (IRQ) via the bus system 305. The IRQ control module 344 selects the one of the at least one processing unit based in information of the IBI requests stored in the memory-2 342. For example, the IRQ control module 344 searches the memory-2 342 by address (e.g., DA; address of the at least one slave issuing the IBI request), by the MDB (e.g., timestamp), or by the additional data. The IRQ control module 344 selects the one of the at least one processing unit based on time (e.g., timestamps of the IBI requests) or urgency determined in the stored information of the IBI requests. For example, a panic mode IBI request is selected before other IBI requests. In such fashion, the IRQ control module 344 signals the IRQs to different ones of the at least one processing unit out of order with an order of the IBI detection module 330 detecting and receiving the corresponding IBI requests.

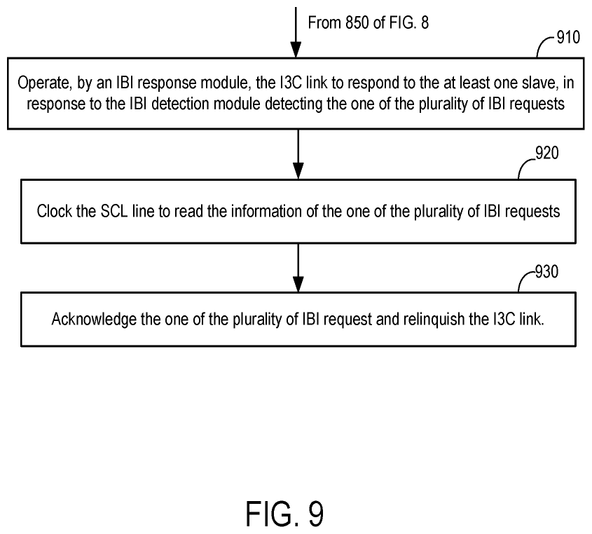

The method of FIG. 8 may continue at 910 of FIG. 7. FIG. 9 illustrates a second portion of the method for IBI handling of FIG. 8. The operations of FIG. 9 may be implemented by, for example, the apparatus 200 presented with FIGS. 2, 3, 4, and/or 5. The arrows indicate certain relationships among the operations, but not necessarily sequential relationships. At 910, the I3C link is operated by an IBI response module to respond to the at least one slave, in response to the IBI detection module detecting the one of the plurality of IBI requests. For example, referring to FIG. 3 and FIG. 4, the IBI response module 350 operates the I3C link to respond (e.g., to ACK an IBI request and/or to relinquish the I3C bus by putting the I3C bus in the Bus Free Condition), in response to the IBI detection module 330 detecting IBI request #2 (FIG. 5).

At 920, the SCL line is clocked to read the information of the one of the plurality of IBI requests. For example, referring FIG. 3 and FIG. 4, the SCL generator 352 (incorporated within the IBI response module 350) clocks the SCL line 312 to read in the address of the at least one slave requesting the IBI, the RnW bit, the MDB, and/or the addition data of the IBI request. At 930, the one of the plurality of IBI request is acknowledged and the I3C link is relinquished. For example, referring to FIG. 3 and FIG. 4, the IBI response module 350 operates the I3C link 310 (the SCL line 312 and the SDA line 314) to ACK the IBI request (e.g., the IBI request #1 or the IBI request #2 of FIGS. 4). At T3 and T4 of FIG. 4. the IBI response module 350 operates the I3C link 310 (the SCL line 312 and the SDA line 314) to relinquish the I3C link by pulling the SCL line 312 High or the SDA line 314 High. The I3C link 310 following T4 is relinquished by the IBI handling module 224 (FIG. 2) and is in a Buss Free Condition ready to receive a new IBI request.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. An apparatus, comprising:
at least one processing unit;
a host controller configured to communicate with at least one slave via an I3C link and configured to enter into a sleep mode or a power-down mode, wherein the I3C link comprises a serial clock (SCL) line and a serial data (SDA) line;
an IBI detection module configured to detect on the SDA line, while the host controller is in the sleep mode or the power-down mode, an in-band interrupt (IBI) request from the at least one slave; and
a processing unit interrupt control module configured to signal a processing unit interrupt to the at least one processing unit based on information of the IBI request, in response to the IBI detection module detecting the IBI request.

2. The apparatus of claim 1, further comprising a memory configured to store the information of the IBI request, wherein the processing unit interrupt control module is configured to signal the processing unit interrupt based on the information of the IBI request stored in the memory.

3. The apparatus of claim 2, wherein the information of the IBI request comprises an address of the at least one slave and at least a portion of a mandatory data byte of the IBI request detected by the IBI detection module.

4. The apparatus of claim 3, wherein the information of the IBI request further comprises a timestamp of the IBI request detected by the IBI detection module.

5. The apparatus of claim 3, further comprising an IBI response module configured to operate the I3C link to respond to the at least one slave, in response to the IBI detection module detecting the IBI request, in the case the host controller is in the sleep mode or the power-down mode.

6. The apparatus of claim 5, wherein the IBI response module is further configured to respond to the at least one slave by clocking the SCL line to read the information of the IBI request.

7. The apparatus of claim 5, wherein the IBI response module is further configured to respond to the at least one slave by operating the I3C link to acknowledge the IBI request and to relinquish the I3C link.

8. The apparatus of claim 7, wherein the interrupt detection module is further configured to detect, on the SDA line, a plurality of IBI requests from the at least one slave, the plurality of IBI requests comprising the IBI request, and
the processing unit interrupt control module is further configured to signal the processing unit interrupt, as an initial processing unit interrupt, to the at least on processing unit, after the IBI detection module detects the plurality of IBI requests, in the case the host controller is in the sleep mode or the power-down mode.

9. The apparatus of claim 8, wherein the processing unit interrupt control module is further configured to signal a second processing unit interrupt to the at least on processing unit, after the interrupt detection module detects the plurality of IBI requests, in the case the host controller is in the sleep mode or the power-down mode, and
wherein the processing unit interrupt and the second processing unit interrupt are not signaled in order of the IBI detection module detecting corresponding IBI requests.

10. The apparatus of claim 9, further comprising one of a computing system, a mobile computing system, an Internet of Things device, and a virtual reality or augmented reality system incorporating the at least one processing unit, the host controller, the I3C link, the IBI detection module, the memory, the processing unit interrupt control module, the IBI response module, and the at least one slave.

11. An apparatus, comprising:
at least one processing unit;
a host controller configured to communicate with at least one slave via an I3C link, the I3C link comprising a serial clock (SCL) line and a serial data (SDA line);
an IBI handling module configured to detect, on the SDA line, a plurality of IBI requests from the at least one slave while the host controller is in a sleep mode or a power-down mode, the IBI handling module being further configured to receive information of the plurality of IBI requests from the at least one slave on the SDA line while the host controller is in the sleep mode or the power-down mode, the information of the plurality of IBI requests comprising information of the one of the plurality of IBI requests; and
the IBI handling module being further configured to select one of the at least one processing unit and to signal an initial processing unit, while the host controller is in the sleep mode or the power-down mode, in response to the IBI handling module detecting the one of the plurality of IBI requests and based on the information of the one of the plurality of IBI requests.

12. The apparatus of claim 11, wherein the IBI handling module is further configured to signal a second processing unit interrupt, in response to the IBI handling module detecting a second one of the plurality of IBI requests, and
wherein the initial processing unit interrupt and the second processing unit interrupt are not signaled in an order of the IBI handling module detecting the one and the second one of the plurality of IBI requests.

13. The apparatus of claim 12, further comprising a memory configured to store the information of the plurality of IBI requests.

14. The apparatus of claim 13, wherein the information of the plurality of IBI requests comprises an address of the at least one slave and at least a portion of a mandatory byte of the one of the plurality of IBI requests.

15. The apparatus of claim 14, wherein the information of the plurality of IBI requests further comprises a timestamp of the one of the plurality of IBI requests.

16. The apparatus of claim 14, further comprising an IBI handling module configured to operate the I3C link to respond to the at least one slave, in response to the IBI handling module detecting the one of the plurality of IBI requests.

17. The apparatus of claim 16, wherein the IBI handling module is further configured to respond to the at least one slave by clocking the SCL line to read the information of the one of the plurality of IBI requests.

18. The apparatus of claim 17, wherein the IBI handling module is further configured to respond to the at least one slave by operating the I3C link to acknowledge the one of the plurality of IBI request and to relinquish the I3C link.

19. The apparatus of claim 18, further comprising the at least one slave and the I3C link.

20. The apparatus of claim 19, further comprising one of a computing system, a mobile computing system, an Internet of Things device, and a virtual reality or augmented reality system incorporating the at least one processing unit, I3C link, the IBI handling module, the host controller, and the at least one slave.

21. A method for in-band interrupt (IBI) handling in a sleep mode or a power-down mode:
communicating between a host controller and at least one slave via an I3C link, the I3C link comprises a serial clock (SCL) line and a serial data (SDA) line;
entering into the sleep mode or the power-down mode by the host controller;
detecting, by an IBI detection module while the host controller is in the sleep mode or the power-down mode, an IBI request on the SDA line from the at least one slave;
signaling, by a processing unit interrupt control module, a processing unit interrupt to at least one processing unit based on information of the IBI request, in response to the IBI detection module detecting the IBI request.

22. The method of claim 21, further comprising
storing the information of the IBI request in a memory, wherein the signaling, by the processing unit interrupt control module, the processing unit interrupt to at least one processing unit is based on the information of the IBI request stored in the memory.

23. The method of claim 22, wherein the information of the IBI request comprises an address of the at least one slave and at least a portion of a mandatory byte of the IBI request detected by the IBI detection module.

24. The method of claim 23, wherein the information of the IBI request further comprises a timestamp of the IBI request detected by the IBI detection module.

25. The method of claim 23, further comprising
operating, by an IBI response module, the I3C link to respond to the at least one slave, in response to the IBI detection module detecting the IBI request, while the host controller is in the sleep mode or the power-down mode.

26. The method of claim 25, wherein the operating, by the IBI response module, the I3C link to respond to the at least one slave comprises clocking the SCL line to read the information of the IBI request.

27. The method of claim 25, wherein the operating, by the IBI response module, the I3C link to respond to the at least one slave further comprises acknowledging the IBI request and relinquishing the I3C link.

28. The method of claim 27, further comprising
detecting on the SDA line, by the interrupt detection module a plurality of IBI requests from the at least one slave, the plurality of IBI requests comprising the IBI request, and
signaling, by the processing interrupt control module, the processing unit interrupt, as an initial processing unit interrupt, to the at least on processing unit, after the IBI detection module detects the plurality of IBI requests, while the host controller is in the sleep mode or the power-down mode.

29. The method of claim 28, further comprising
signaling, by the processing unit interrupt control module, a second processing unit interrupt to the at least one processing unit, after the interrupt detection module detects the plurality of IBI requests, while the host controller is in the sleep mode or the power-down mode, and
wherein the processing unit interrupt and the second processing unit interrupt are not signaled in order of the IBI detection module detecting corresponding IBI requests.

30. A method for in-band interrupt (IBI) handling:
communicating between a host controller and at least one slave via an I3C link, the I3C link comprises a serial clock (SCL) line and a serial data (SDA) line;
the method further comprising, while the host controller is in a sleep mode or a power-down mode:
detecting, by an IBI handling module, a plurality of IBI requests on the SDA line from the at least one slave;
receiving, by the IBI handling module, information of the plurality of IBI requests from the at least one slave on the SDA line, the information of the plurality of IBI requests comprising information of one of the plurality of IBI requests;
selecting one of at least one processing unit and signaling, by the IBI handling module, an initial processing unit interrupt, in response to the IBI handling module detecting the one of the plurality of IBI requests and based on the information of the one of the plurality of IBI requests.

31. The method of claim 30, further comprising
signaling, by the IBI handling module, a second processing unit interrupt, in response to the IBI handling module detecting a second one of the plurality of IBI requests,
wherein the initial processing unit interrupt and the second processing unit interrupt are not signaled in an order of the IBI handling module detecting the one and the second one of the plurality of IBI requests.

32. The method of claim 31, further comprising
storing, in a memory, the information of the plurality of IBI requests.

33. The method of claim 32, wherein the information of the plurality of IBI requests comprises an address of the at least one slave and at least a portion of a mandatory byte of the one of the plurality of IBI requests.

34. The method of claim 33, wherein the information of the plurality of IBI requests further comprises a timestamp of the one of the plurality of IBI requests.

35. The method of claim 33, further comprising
operating, by an IBI handling module, the I3C link to respond to the at least one slave, in response to the IBI handling module detecting the one of the plurality of IBI requests.

36. The method of claim 35, wherein the operating, by the IBI handling module, the I3C link to respond to the at least one slave comprises clocking the SCL line to read the information of the one of the plurality of IBI requests.

37. The apparatus of claim 36, wherein the operating, by the IBI handling module, the I3C link to respond to the at least one slave comprises acknowledging the one of the plurality of IBI request and relinquishing the I3C link.
